(19) United States
(12) Patent Application Publication
(10) Pub. No.: US 2012/0047571 A1
(43) Pub. Date: Feb. 23, 2012

(54) SYSTEMS AND METHODS FOR DETECTING PRESELECTED QUERY TYPE WITHIN A DNS QUERY

(76) Inventors: Richard Jeremy Duncan, Fairfax, VA (US); Ronald Scott Hulen, Ashburn, VA (US)

(21) Appl. No.: 12/857,742

(22) Filed: Aug. 17, 2010

(51) Int. Cl. G06F 21/00; G06F 15/16

(52) U.S. Cl. 726/13

(57) ABSTRACT

In some embodiments, a non-transitory processor-readable medium storing code representing instructions to cause a processor to perform a process includes code to determine whether an IPv4 packet is associated with a Domain Name System (DNS) query based on an IPv4 header of the IPv4 packet. If the IPv4 packet is a DNS query packet, the non-transitory processor-readable medium includes code to determine whether the IPv4 packet has a preselected query type based on a payload of the IPv4 packet. If the IPv4 packet is a DNS query packet and has the preselected query type, the non-transitory processor-readable medium includes code to send a signal to block transmission of the IPv4 packet. In some embodiments, the preselected query type has a DNS record type value of 28.

### CROSS-REFERENCE TO RELATED APPLICATIONS

This application is related to co-pending U.S. Non-provisional patent applications bearing Attorney Docket Nos. COMM-003/00US and COMM-005/00US, each filed on the same date herewith, and entitled “Decapsulation of Data Packet Tunnels to Process Encapsulated IPv4 or IPv6 Packets” and “Methods and Apparatus for Detecting Invalid IPv6 Packets,” respectively, both of which are incorporated herein by reference in their entirety.

### BACKGROUND

Some embodiments relate to systems and methods for the inspection and filtering of data packets, and more particularly to systems and methods for the detection and filtering of preselected query types within an IPv4-transit Domain Name System query packet.

The IPv4 Internet Protocol (IP) has been the primary Internet Layer Protocol used to support standard packet-switched Internet methods. The next generation Internet Protocol, IPv6 is now being more widely used, but is still relatively new. Many systems either support the IPv4 IP or the IPv6 IP, resulting in various issues that can arise associated with data transmission between the two versions.

For example, the differences between the IPv4 IP and the IPv6 IP can result in problems associated with Domain Name System (DNS) query packets. Within a DNS query packet, the IPv4 IP address is designated by an A resource record type, while an IPv6 IP address is designated by an AAAA resource record (also referred to as quad-A records). In some instances, an IPv4 DNS query packet can include an IPv6 query type (e.g., AAAA resource record), which can result in various problems in processing the request or can be an indication of a potentially harmful or malicious communication.

Known network protection and packet-filtering solutions perform analysis and inspection of incoming network communications so as to detect potentially malicious data packets. Known solutions, however, fail to account for vulnerabilities inherent in many transition mechanisms defined to facilitate the Internet's transition from IPv4 to IPv6.

Thus, a need exists for methods and systems to inspect incoming network data for potential threats included in packets defined according to one or more such IPv6 transition mechanisms.

### SUMMARY

In some embodiments, a non-transitory processor-readable medium storing code representing instructions to cause a processor to perform a process includes code to determine whether an IPv4 packet is associated with a Domain Name System (DNS) query based on an IPv4 header of the IPv4 packet. If the IPv4 packet is a DNS query packet, the non-transitory processor-readable medium includes code to determine whether the IPv4 packet has a preselected query type based on a payload of the IPv4 packet. If the IPv4 packet is a DNS query packet and has the preselected query type, the non-transitory processor-readable medium includes code to send a signal to block transmission of the IPv4 packet. In some embodiments, the preselected query type has a DNS record type value of 28.

### BRIEF DESCRIPTION OF THE DRAWING

FIG. 1 is a schematic diagram of a packet filtering system, according to an embodiment.

FIG. 2 is a schematic diagram of a packet inspection unit, according to an embodiment.

FIG. 3 is a block diagram of a packet filtering system and network, according to an embodiment.

FIG. 4 is a diagram showing an example of a portion of a data packet, according to an embodiment.

FIG. 5 is a diagram showing example parameters and criteria associated with detection of a query type within a data packet, according to an embodiment.

FIG. 6 is a diagram showing example parameters and criteria associated with detection of a query type within a data packet, according to an embodiment.

FIG. 7 is a table showing an example of a DNS resource record for an IPv4 DNS query and an IPv6 DNS query.

FIG. 8 is a flowchart illustrating a method of detecting an IPv6 query type within an IPv4 DNS query packet.

FIG. 9 is a flowchart illustrating a method of detecting a preselected query type of a DNS query packet, according to an embodiment.

FIG. 10 is a flowchart illustrating a method of detecting a preselected query type of a DNS query packet, according to an embodiment.

### DETAILED DESCRIPTION

Systems and methods are described herein to inspect and filter data packets received at a network server or system based on preselected filtering policies. As described herein, in some embodiments, a gateway device is disposed on the ingress side of a network that can receive an IPv4 or IPv6 packet. The gateway device can be operatively and/or physically coupled to one or more packet inspection units configured to inspect and apply filter policies to incoming data packets. In some embodiments, the gateway device can be further physically and/or operatively coupled to a policy unit configured to define and transmit such filter policies for translation by the gateway device and application by the one or more packet inspection units. In some embodiments, the gateway device can be operatively and/or physically coupled to a reporting and analysis unit configured to perform analysis on allowed and/or blocked data packets in both individual instances and in aggregate.

Each packet inspection unit can be, for example, a hardware-based module and/or a software-based module (executing on hardware) or device configured to inspect incoming data packets for one or more IPv6 transition vulnerabilities. In some embodiments, the packet inspection unit can inspect a header and/or payload of an incoming data packet. The packet inspection unit can optionally be configured to inspect successive levels or layers of tunneled packets included in an incoming IPv4 or IPv6 data packet. In some embodiments, the packet inspection unit can receive one or more filter policies from the gateway device and/or the policy unit described above. In such embodiments, the packet inspection unit can apply one or more such filter policies subsequent to or as part of the packet inspection process. After applying the one or more filter policies, the packet inspection unit can next determine whether the inspected data packet should be blocked from access to the network, allowed into the network, or sent for further processing and analysis by another module or device within or outside the packet inspection unit.

In some embodiments, the packet inspection unit can use the one or more filter policies to detect or determine a query type associated with an incoming IPv4 packet. For example, in some embodiments a packet inspection unit can use a filter policy to determine whether an IPv4 data packet is a Domain Name System (DNS) query packet. Once a DNS query packet is found, the query type of the data packet can be determined by examining the payload of the data packet to determine an end of a query name of the packet. The query type can be determined based on the location of an end of the query name of the data packet. With the location of the query type known, the query type can be examined to determine if it is equal to a preselected query type. For example, the query type can be examined to determine if it has a preselected value equal to 28, which is the DNS resource record type value for an IPv6 DNS query (i.e., AAAA query). The IPv4 data packet can also be examined to determine if the packet is a User Datagram Protocol (UDP) format or a Transmission Control Protocol (TCP) format based on the IPv4 header of the IPv4 packet. Depending on which format the IPv4 packet includes, the determination of the end of the query name of the IPv4 packet can vary. Further details of such a system and method are described herein.

In some embodiments, a non-transitory processor-readable medium storing code representing instructions to cause a processor to perform a process includes code to determine whether an IPv4 packet is associated with a DNS query based on an IPv4 header of the IPv4 packet. If the IPv4 packet is a DNS query packet, the non-transitory processor-readable medium includes code to determine whether the IPv4 packet has a preselected query type based on a payload of the IPv4 packet. If the IPv4 packet is a DNS query packet and has the preselected query type, the non-transitory processor-readable medium includes code to send a signal to block transmission of the IPv4 packet. In some embodiments, the preselected query type has a DNS record type value of 28.

In some embodiments, a non-transitory processor-readable medium storing code representing instructions to cause a processor to perform a process includes code to determine whether the IPv4 packet has a UDP format based on a IPv4 header of the IPv4 packet when the IPv4 packet is associated with a DNS query. The non-transitory processor-readable medium further includes code to determine an end of a query name of the IPv4 packet based on a preselected byte sequence within a payload of the IPv4 packet if the IPv4 packet has the UDP format and is associated with the DNS query. The non-transitory processor-readable medium can then determine whether the IPv4 packet has a preselected query type based on the end of the query name of the IPv4 packet and to send a signal to block transmission of the IPv4 packet if the IPv4 packet has the preselected query type.

In some embodiments, a non-transitory processor-readable medium storing code representing instructions to cause a processor to perform a process includes code to determine whether an IPv4 packet is associated with a DNS query based on an IPv4 header of the IPv4 packet. The non-transitory processor-readable medium includes code to determine whether the IPv4 packet has a UDP format or a TCP format based on the IPv4 header of the IPv4 packet when the IPv4 packet is associated with the DNS query and to determine whether the IPv4 packet has a preselected query type based on a payload of the IPv4 packet and based on whether the IPv4 packet has the UDP format or the TCP format. If the IPv4 packet has the preselected query type, the non-transitory processor-readable medium includes code to send a signal to block transmission of the IPv4 packet.

The UDP and TCP are core transport layer protocols of the set of network protocols used for the Internet (referred to as the “Internet Protocol Suite”). The UDP and TCP can be used to send messages (referred to as datagrams when the UDP format is used) on an Internet Protocol (e.g., IPv4 IP, IPv6 IP) network. The UDP is considered to be somewhat unreliable because it does not guarantee reliability, ordering or data integrity. Such a format may be desirable, for example, for transmission of time-sensitive packets. When more reliability is desired, the TCP format can be used. The TCP operates at a higher level and can provide a reliable, ordered delivery of a stream of bytes.

In some embodiments, the policy unit can include a user interface that allows an individual, such as a network administrator, to define one or more filter policies for application by the one or more packet inspection units. In such embodiments, the policy unit can include a web interface. In some embodiments, the reporting and analysis unit can include a web and/or other interface configured to allow an individual, such as a network or system administrator, to generate one or more logs, reports, charts, graphs or other formatted data associated with the history of incoming data packets received and filtered by the gateway device and one or more packet inspection units.

As used in this specification, the singular forms “a,” “an” and “the” include plural referents unless the context clearly dictates otherwise. Thus, for example, the term “a module” is intended to mean a single module or a combination of modules.

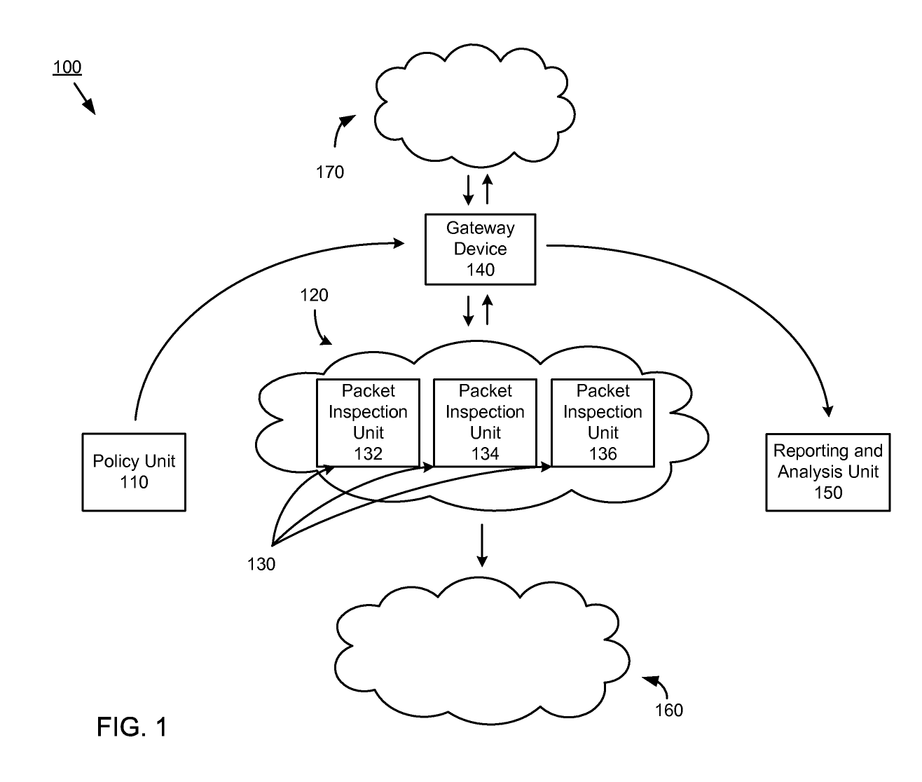

FIG. 1 is a schematic diagram that illustrates a packet filtering system, according to an embodiment. More specifically, FIG. 1 illustrates Packet Filtering System 100. The Packet Filtering System 100 includes Packet Inspection Unit 132, Packet Inspection Unit 134 and Packet Inspection Unit 136 (collectively referred to as Packet Inspection Units 130) included in a Packet Inspection Network 120 and each in communication with a Gateway Device 140 and a Client Network 160. The Gateway Device 140 is in further communication with a Policy Unit 110, a Reporting and Analysis Unit 150 and an External Network 170.

The Policy Unit 110 can be any combination of hardware and/or software (executing on hardware) configured to transmit one or more filter policies to one or more of the Packet Inspection Units 130. In some embodiments, the Policy Unit 110 can be operatively and/or physically coupled to the Gateway Device 140. For example, the Policy Unit 110 can be coupled to the Gateway Device 140 via a wired and/or wireless data connection, such as a wired Ethernet connection, a wireless 802.11x (“Wi-Fi”) connection, etc. In some embodiments, the Policy Unit 110 can be one of multiple such policy units included in the Packet Filtering System 100. The Policy Unit 110 can optionally be or can be disposed within a server device (not shown in FIG. 1). In some embodiments, the Policy Unit 110 can be included in the same hardware device as the Gateway Device 140 and/or one or more of the Packet Inspection Units 130.

The Policy Unit 110 can optionally include a web-based interface that enables an administrator or other user of the Packet Filtering System 100 to create, define, clone, import or export filter policies or other policies, rules, instructions or directives. In some embodiments, the Policy Unit 110 can transmit a filter policy to the Gateway Device 140. The filter policy can include one or more rules that define when various packets or packet types are to be allowed into the Packet Inspection Network 120, blocked therefrom, or sent for further processing before being ultimately allowed or blocked from the Packet Inspection Network 120. In some embodiments, the Policy Unit 110 can include one or more default filter policies.

The Packet Inspection Network 120 can be comprised of one or more packet inspection units, such as the Packet Inspection Units 130. In some embodiments, the Packet Inspection Network 120 can include one or more switching and/or routing devices configured to direct network traffic (i.e., incoming data packets) received from the Gateway Device 140 to and/or between the Packet Inspection Units 130. In some embodiments, the one or more switching and/or routing devices can be configured to direct network traffic (including, e.g., filter results) from the Packet Inspection Units 130 to the Gateway Device 140.

The Packet Inspection Units 130 can each be any combination of hardware and/or software (executing on hardware) configured to apply one or more filter policies to one or more incoming data packets (not shown in FIG. 1). In some embodiments both the filter policies and incoming data packets can be received at the Packet Inspection Units 130 via the Gateway Device 140. In some embodiments, the Packet Inspection Units 130 can each be configured to apply one or more filter policies to an incoming data packet to determine whether that data packet should be forwarded onto or permitted to be accessed by one or more other devices included in the Client Network 160. The Packet Inspection Units 130 can thus prevent potentially malicious data packets from reaching devices within the Client Network 160, and thereby thwart security breaches and/or other remote attacks. In some embodiments, the Packet Inspection Units 130 can include one or more hardware and/or software modules, such as third-party modules configured to inspect and/or apply filter policies or rules on incoming data packets.

In some embodiments, one or more of the Packet Inspection Units 130 can be a server computing device operatively and/or physically coupled to the Gateway Device 140. For example, the Packet Inspection Unit 134 can be coupled to the Gateway Device 140 via a wired and/or wireless data connection, such as a wired Ethernet connection, a wireless 802.11x (“Wi-Fi”) connection, and/or a WiMax, Ultra-wideband (UWB), Universal Serial Bus (USB), Bluetooth, infrared, cellular network, or other wireless data connection. In some embodiments, the Packet Inspection Unit 134 can be in communication with the Gateway Device 140 via one or more switching and/or routing devices (not shown) included in the Packet Inspection Network 120. In some embodiments, one or more of the Packet Inspection Units 130 can be included in a single device. In some embodiments, one or more of the Packet Inspection Units 130 can be included in the same hardware device as the Gateway Device 140, the Policy Unit 110 and/or the Reporting and Analysis Unit 150. Alternatively, one or more of the Packet Inspection Units 130 can be disposed within separate or distinct devices from one another and/or from the Gateway Device 140, the Policy Unit 110 and/or the Reporting and Analysis Unit 150. In some embodiments, the Packet Filtering System 100 can include any number of packet inspection units sufficient to perform filtering on all or a portion of incoming data packets received at, for example, the Gateway Device 140.

In some embodiments, the Gateway Device 140 can be any combination of hardware and/or software (executing on hardware) configured to act as a central point of exchange for incoming data packets and/or filter policies within the Packet Filtering System 100. As shown in FIG. 1, the Gateway Device 140 can exchange information with the External Network 170 and the Packet Inspection Units 130, receive information from the Policy Unit 110 and transmit information to the Reporting and Analysis Unit 150. For example, in some embodiments the Gateway Device 140 can receive one or more incoming data packets from the External Network 170, and one or more filter policies from the Policy Unit 110. In such embodiments, the Gateway Device 140 can transmit the one or more incoming data packets received from the External Network 170 to one or more of the Packet Inspection Units 130 for application of filter polices and/or rules. In some embodiments, the Gateway Device 140 can be further configured to receive filter results and/or events from one or more of the Packet Inspection Units 130. The Gateway Device 140 can additionally transmit information associated with filter results and/or events to the Reporting and Analysis Unit 150. Although not shown in FIG. 1, in some embodiments the Gateway Device 140 can transmit information to the Policy Unit 110 and/or receive information from the Reporting and Analysis Unit 150.

In some embodiments, the Gateway Device 140 can be a hardware device, such as a server device operatively and/or physically coupled to the Policy Unit 110. In some embodiments, the Gateway Device 140 can include or comprise one or more devices included in the Packet Filtering System 100 (such as the Policy Unit 110, one or more of the Packet Inspection Units 130 and/or the Reporting and Analysis Unit 150). In some embodiments, the Gateway Device 140 can be or be included in a single hardware device, and/or be included in a single or multiple hardware devices along with one or more of the Policy Unit 110, one or more of the Packet Inspection Units 130 and/or the Reporting and Analysis Unit 150. In some embodiments, the Gateway Device 140 can be one of multiple such gateway devices included on the periphery of the Client Network 160, the gateway devices being configured to provide routing and/or other administrative functionality for the Client Network 160. In some embodiments, the Gateway Device 140 can be coupled to one or more of the above-mentioned devices via one or more wired and/or wireless data connections, such as connections conforming to one or more known information exchange standards, such as wired Ethernet, wireless 802.11x (“Wi-Fi”), WiMax, Ultra-wideband (UWB), Universal Serial Bus (USB), Bluetooth, infrared, Code Division Multiple Access (CDMA), Time Division Multiple Access (TDMA), Global Systems for Mobile Communications (GSM), Long Term Evolution (LTE), and the like.

The Reporting and Analysis Unit 150 can be any combination of hardware and/or software (executing on hardware) configured to receive information associated with filter results and/or events from the Gateway Device 140 and provide reporting and analysis to a user and/or administrator of the Packet Filtering System 100. For example, the Reporting and Analysis Unit 150 can provide, via a text, graphical and/or web-based interface, reporting information associated with block and/or allow decisions made by the Packet Inspection Units 130 on incoming data packets. In some embodiments, the reporting and analysis can include aggregated trend information in the form of charts, graphs and the like. In some embodiments, the reporting and analysis can include alert and/or other information designed to notify a user of a particular filtering or network traffic event, such as a suspected attack or atypical amount or type of incoming traffic.

The Client Network 160 can be any computing network. For example, the Client Network 160 can be a local area network (LAN), wide area network (WAN), virtual local area network (VLAN), intranet, or extranet. In some embodiments, the Network 160 can include one or more of: switching and/or routing devices, server and/or client devices, peripheral devices, mobile computing devices, telephony devices, and the like. As shown in FIG. 1, one or more devices included in the Client Network 160 (not shown in FIG. 1) can receive one or more filtered data packets from any of the Packet Inspection Units 130.

In some embodiments, the Policy Unit 110 can receive, via user input, information sufficient to define one or more filter policies. For example, the Policy Unit 110 can receive user input that defines a filter policy that can determine a query type associated with an incoming data packet and if the query type meets certain filtering criteria, can determine if the packet should be blocked, allowed to be transmitted within the Client Network 160 or sent for further processing within the Packet Inspection Network 120.

Upon receipt and/or definition of a filter policy, the Policy Unit 110 can transmit information associated with the filter policy to the Gateway Device 140. In some embodiments, the Policy Unit 110 can transmit the information according to a preselected or predefined policy update schedule. Alternatively or additionally, in some embodiments, the Policy Unit 110 can transmit the information associated with the new filter policy immediately, or after a specified delay period.

Upon receipt of the filter policy information, the Gateway Device 140 can translate the filter policy into a format and/or set of one or more commands that can be interpreted and applied by the Packet Inspection Units 130. In some embodiments, the Gateway Device 140 can then transmit the translated filter policy information to the Packet Inspection Units 130 for use in filtering incoming data packets. In some embodiments, the Gateway Device 140 can also receive one or more incoming data packets from the External Network 170 and forward at least one of the incoming data packets to, for example, the Packet Inspection Unit 136. Each incoming data packet can be, for example, an Internet Protocol version 4 (IPv4) or an Internet Protocol version 6 (IPv6) data packet.

In some embodiments, the Packet Inspection Unit 136 (or any of the Packet Inspection Units 130) can receive the translated filter policy information from the Gateway Device 140. In such embodiments, the Packet Inspection Unit 136 can then receive at least a portion of an incoming data packet from the Gateway Device 140 and apply one or more rules derived from the translated filter policy information to the incoming data packet. For example, in some embodiments the Packet Inspection Unit 136 can analyze a header and/or a payload of the incoming data packet and determine whether or not the incoming data packet meets or violates the one or more rules included in or derived from the translated filter policy information. In some embodiments, the Packet Inspection Unit 136 can detect one or more tunneled packets, i.e., packets encapsulated within the payload of the incoming data packet. In such embodiments, the Packet Inspection Unit 136 can apply the one or more rules on at least a portion of the tunneled packet, such as a header and/or payload of the tunneled packet, or, optionally, a second tunneled packet included in the payload of the initial tunneled packet. In some embodiments, the Packet Inspection Unit 136 can successively detect and analyze tunneled packets encapsulated and/or included in successive encapsulation layers or levels of the incoming data packet.

Upon completion of the analysis, the Packet Inspection Unit 136 can transmit a filter result and/or event to the Gateway Device 140. The filter result can indicate, for example, whether the incoming data packet has satisfied a set of conditions specified by the filter policy described above. For example, the filter result can indicate whether the incoming data packet met or failed to meet particular conditions stipulated by the filter policy. In some embodiments, the filter result can include an instruction based at least in part on the analysis, such as an instruction for the Gateway Device 140 to block at least a portion of the incoming data packet from entering the Packet Inspection Network 120. In some embodiments, the Packet Inspection Unit 136 can transmit the filter result upon completion of the analysis, after a preselected or calculated delay period, or along with one or more other filter results after a preselected quantity of filter results have been calculated.

In some embodiments, the Gateway Device 140 can receive the filter result from the Packet Inspection Unit 136 and take action responsive thereto. For example, if the Gateway Device 140 receives a filter result indicating a failed rule condition and/or indicating a block action, the Gateway Device 140 can block the incoming data packet from entering the Packet Inspection Network 120. In some embodiments, the Gateway Device 140 can block a first portion of the incoming data packet and allow a second portion of the incoming data packet to enter the Packet Inspection Network 120 via one or more network devices (not shown in FIG. 1).

The Gateway Device 140 can additionally be configured to transmit an indication of the filter result and/or the action taken responsive thereto to the Reporting and Analysis Unit 150. In some embodiments, the Gateway Device 140 can transmit the indication upon receipt of the filter result, after having taken the responsive action described above, in accordance with a preselected or predefined schedule, upon receipt of a threshold number of filter results, and/or upon receipt of a threshold number of positive or negative filter results.

In some embodiments, the Reporting and Analysis Unit 150 can receive the indication of the filter result and include it in a log or other record associated with the Packet Filtering System 100. For example, the Reporting and Analysis Unit 150 can store the indication and/or information associated with and/or derived from the indication at a memory, such as a database (not shown in FIG. 1) included in and/or physically or operatively coupled to the Reporting and Analysis Unit 150. In some embodiments, the Reporting and Analysis Unit 150 can perform one or more analyses and/or generate one or more reports, charts and/or graphs based at least in part on the indication. In such embodiments, the Reporting and Analysis Unit 150 can provide an interface, such as a web-based interface, whereby a user of the Packet Filtering System 100 can access information associated with the indication and/or the analysis and reporting information based thereon as described above.

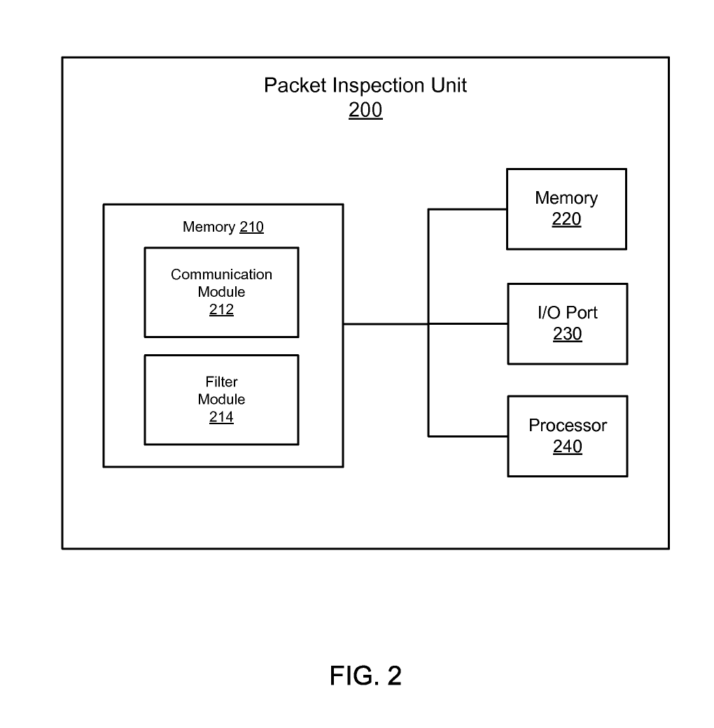

FIG. 2 is a schematic diagram that illustrates a packet inspection unit, according to an embodiment. More specifically, FIG. 2 illustrates Packet Inspection Unit 200 including a Memory 210, a Memory 220, an Input/Output (“I/O”) Port 230 and a Processor 240. The Memory 210 includes a Communication Module 212 and a Filter Module 214. As shown in FIG. 2, each of the Communication Module 212 and the Filter Module 214 can be in communication with each of the Memory 220, the I/O Port 230 and/or the Processor 240. As also shown in FIG. 2, each of the Memory 220, the I/O Port 230 and the Processor 240 can be in communication with one another.

The Packet Inspection Unit 200 can be any combination of hardware components and/or devices configured to receive and apply filter policies to incoming data packets. For example, in some embodiments the Packet Inspection Unit 200 can be a hardware device, such as a server device or system included in, in communication with and/or connected to a network, (not shown in FIG. 2), such as a LAN, a WAN, an extranet, intranet, or the Internet. The Packet Inspection Unit 200 can optionally be configured to receive one or more incoming data packets from a network device (not shown in FIG. 2) and apply one or more filter policies thereon. In some embodiments, the Packet Inspection Unit 200 can store the one or more filter policies in a memory, such as the Filter Module 214 included in the Memory 210. In some embodiments, the Packet Inspection Unit 200 can receive one or more filter policies from another device, such as a gateway device as discussed in connection with FIG. 1 above.

The Memory 210 can be any valid memory, such as, for example, a read-only memory (ROM) or a random-access memory (RAM). In some embodiments, the Memory 210 can be, for example, any type of processor-readable media, such as a hard-disk drive, a compact disc read-only memory (CD-ROM), a digital video disc (DVD), a Blu-ray disc, a flash memory card, or other portable digital memory type. The Memory 210 can optionally be configured to send signals to and receive signals from the Memory 220, the I/O Port 230, and/or the Processor 240.

The Communication Module 212 can be any valid combination of hardware and/or software (executing on hardware) configured to transmit and receive data packet, filter policy and/or filter result information. In some embodiments, the Communication Module 212 can exchange data packet, filter policy and/or filter result information with the Filter Module 214. In some embodiments, the Communication Module 212 can receive incoming data packet and filter policy information from, and transmit filter result information to, the I/O Port 230.

The Filter Module 214 can be any valid combination of hardware and/or software (executing on hardware) configured to inspect one or more incoming data packets and apply one or more filter policies thereon. In some embodiments, the Filter Module 214 can exchange data packet, filter policy and/or filter result information with the Communication Module 212. In some embodiments, the functionality performed by the Filter Module 214 can optionally be performed by two distinct modules, such as an inspection module (not shown in FIG. 2) and a filter module. In such embodiments, the inspection module can inspect an incoming data packet or data packet portion to identify characteristics of the incoming data packet or data packet portion, such as header length, header contents, payload length, payload contents, one or more protocols specified by the data packet header, the presence or absence of encapsulated packets in the data packet payload, etc. In such embodiments, the filter module can apply one or more filter policies to the inspected data packet or data packet portion to make a block or allow determination.

The Memory 220 can be any valid memory, such as, for example, a read-only memory (ROM) or a random-access memory (RAM). In some embodiments, the Memory 220 can be, for example, any type of processor-readable media, such as a hard-disk drive, a compact disc read-only memory (CD-ROM), a digital video disc (DVD), a Blu-ray disc, a flash memory card, or other portable digital memory type. The Memory 220 can optionally be configured to send signals to and receive signals from the Memory 210, the I/O Port 230, and/or the Processor 240.

The I/O Port 230 can be any valid combination of hardware and/or software (executing on hardware) configured to receive information at and transmit data from the Packet Inspection Unit 200. In some embodiments, the I/O Port 230 can be a hardware network communication device and/or a software module configured to format and transmit data to and from the hardware communication device. For example, in some embodiments, the I/O Port 230 can include network interface card (NIC), such as a wired and/or wireless Ethernet card, and an associated software device driver. As shown in FIG. 2, the I/O Port 230 can also transmit signals to and receive signals from the Memory 210, the Memory 220 and/or the Processor 240.

The Processor 240 can be any valid hardware processor configured to execute instructions, such as computing instructions included in and/or defined by the Communication Module 212 and/or the Filter Module 214. The Processor 240 can be, for example, an application-specific integrated circuit (ASIC), a digital signal processor (DSP), a field programmable gate array (FPGA), etc. As shown in FIG. 2, the Processor 240 can transmit signals to and receive signals from the Memory 210, the Memory 220 and/or the I/O Port 230. In some embodiments, the Processor 240 can access computing instructions in the Memory 220 for execution at the Processor 240 and then transmit information, including computed results, to the Memory 220.

In some embodiments, the I/O Port 230 can receive at least one filter policy from, for example, a policy unit and/or gateway device as discussed in connection with FIG. 1 above. The I/O Port 230 can then transmit the filter policy to the Communication Module 212 for subsequent transmission to the Filter Module 214. In some embodiments, the Filter Module 214 can already include one or more filter policies, the filter policies having been loaded at a previous time, such as during an initial device setup and/or software installation.

In some embodiments, the I/O Port 230 can receive at least one incoming data packet from, for example, a gateway device (as discussed in connection with FIG. 1 above). The I/O Port 230 can then transmit the incoming data packet to the Filter Module 214 via the Communication Module 212. In some embodiments, the incoming data packet can be, for example, an IPv4 packet, an IPv6 packet, or other known data packet type. The incoming data packet can contain a header and/or a payload as required by its data packet type or definition. For example, when the incoming data packet is an IPv4 data packet, the incoming data packet can include a variable-length header and a variable-length payload. The payload can optionally include data, such as application data and/or a tunneled packet (i.e., encapsulated packet).

The Filter Module 214 can next determine whether one or more conditions specified by a given filter policy are satisfied by the incoming data packet or a portion of the incoming data packet. In some embodiments, the Filter Module 214 can then apply the filter policy to determine whether the data packet or data packet portion should be allowed into the network, blocked from the network, or sent to another module or device for further processing. In some embodiments, the Filter Module 214 can determine that a portion of the incoming data packet, such as a payload of the incoming data packet, should be sent to another portion of code included in the Filter Module 214 for further processing. In such embodiments, the Filter Module 214 can then transmit, via the Communication Module 212 and the I/O Port 230, a filter result associated with the determination. The filter result can include, for example, an indication that the data packet or data packet portion did or did not satisfy all requirements of a filter policy applied thereto or thereon. In some embodiments, the filter result can include an indication that the incoming data packet or incoming data packet portion should or should not be allowed into the network. In such embodiments, the filter result can include an “allow” or “block” indicator configured or formatted to instruct a device, such as a gateway device, to accordingly allow or block the incoming data packet or incoming data packet portion.

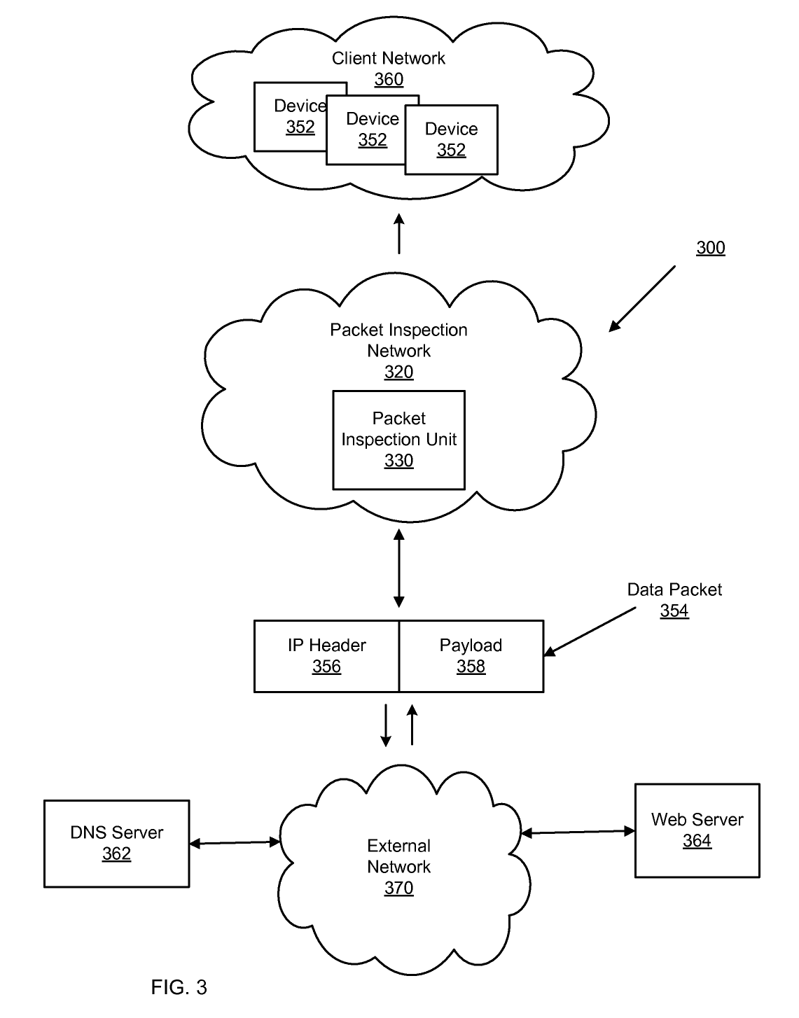

FIGS. 3-7 illustrate a system and method of inspecting and filtering a data packet received at a packet inspection network and/or a gateway device as described above, and more specifically, a system and method for detecting a preselected query type within an incoming data packet, according to an embodiment. As shown in FIG. 3, a Packet Filtering System 300 includes a Packet Inspection Network 320 that includes one or more Packet Inspection Units 330 (only one shown in FIG. 3). The Packet Inspection Network 320 can be configured, for example, as described above for Packet Inspection Network 120.

The Packet Inspection Units 330 can be in communication with a gateway device (not shown in FIG. 3) and a Client Network 360. The gateway device can be in communication with a policy unit (not shown in FIG. 3) and a reporting and analysis unit (not shown in FIG. 3) as described above with reference to FIG. 1. The Packet Inspection Units 330, gateway device, policy unit, and reporting and analysis unit can each be configured and function as described above to manage and route computer traffic attempting to enter the Client Network 360.

The Packet Inspection Network 320 can be in communication with an External Network 370 via for example, the gateway device. The Packet Inspection Network 320 can be in communication with a web server 364 and a DNS server 362 via the External Network 370. The web server 364 can be supported, for example, by the IPv4 Internet Protocol and/or the IPv6 Internet Protocol.

The Client Network 360 can include one or more Computer Devices 352. In instances where only one Computer Device 352 is present, a network need not be present. The Computer Devices 352 can be any of a variety of communication devices that can be operatively coupled to Client Network 360 and/or External Network 370 and/or Packet Inspection Network 320. For example, a Computer Device 352 can be a personal computer, a laptop computer, a personal digital assistant (PDA), a cellular telephone, and/or some other communication device. Computer devices 352 can include a web browser configured to access a webpage or website hosted on or accessible via web server 364 over External Network 370. A webpage or website can be accessed by a user of a web browser at computer devices 352 by providing the web browser with a reference such as a uniform resource locator (URL), for example, of a webpage. In some embodiments, computer devices 352 can include specialized software for accessing web server 364 other than a browser such as, for example, a specialized network-enabled application or program. The DNS server 362 stores DNS records, such as Internet address records, name server records, and mail exchanger records for a domain name and responds to queries by searching within its database for requested domain names and IP addresses.

The External Network 370 can be any communications network configurable to allow web server 364, DNS server 362, Packet Inspection Network 320, etc. to communicate with External Network 370 and/or to each other through External Network 370. In other words, External Network 370 can be any network or combination of networks capable of transmitting information (e.g., data and/or signals) including, for example, a telephone network, an Ethernet network, a fiber-optic network, a wireless network, and/or a cellular network. The External Network 370, can be, for example, the Worldwide Web or Internet.

A data packet 354 can be received at the Packet Inspection Network 320 (e.g., via the gateway device), as shown in FIG. 3. In this example, the data packet 354 is an Internet Protocol version 4 (IPv4) packet. In other embodiments, data packet 354 can be, for example, an Internet Protocol version 6 (IPv6) data packet, as described previously. Before allowing transmission of the data packet 354 within the Client Network 360, the Packet Inspection Unit 330 can apply one or more filtering policies to examine or inspect the data packet 354 to determine if the data packet 354 should be blocked, allowed transmission into the Client Network 360, or sent, for example, to another unit or module within the Packet Filtering System 300 for further processing. In this example described with reference to FIGS. 3-7, the Packet Inspection Unit 330 is configured to apply a filtering policy to determine if the data packet 354 is associated with a DNS query packet, based on preselected criteria. It should be understood, however, that the Packet Inspection Unit 330 can be configured to examine the data packet 354 to determine if the data packet 354 is associated with other types of query packets.

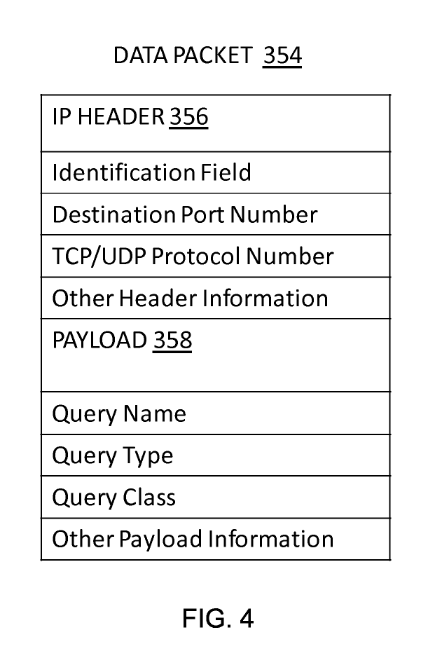

As shown in FIGS. 3 and 4, the data packet 354 includes an IP header 356 and a payload 358. As shown in FIG. 4, the header 356 can include information, such as, for example, an identification field uniquely identifying the IP datagram, a destination port number, a TCP/UDP designation, including an IP protocol number indicating the transport layer format of the data packet, and other header information. The payload 358, also referred to as the body or data of the packet, can include, for example, a query name, a query type, a query class and other payload information. Depending on the transport layer format of the data packet 354, the data packet can also include either a TCP header or a UDP header (not shown). The TCP/UDP header typically follows the IP header (but before the payload 358) and supplies information specific to the particular protocol.

As mentioned above, when the data packet 354 is received at the Packet Inspection Network 320, the Packet Inspection Unit 330 can apply a filtering rule to determine if the data packet 354 is a DNS query packet. In this example, the Packet Inspection Unit 330 examines the header 356 of the data packet 354 to determine if it includes destination port number 53, which indicates that the data packet is a DNS query packet. In some embodiments, the destination port number can be found, for example, in bytes 16-31 of the header 356 of the data packet 354. The Packet Inspection Unit 330 can also examine the TCP/UDP IP protocol number within the header 356 to determine if the data packet 354 includes a TCP transport layer format or a UDP transport layer format. For example, if the TCP/UDP Internet Protocol number is 6, the data packet 354 is in a TCP IP format, and if the TCP/UDP Internet Protocol number is 17, the data packet 354 is in a UDP IP format.

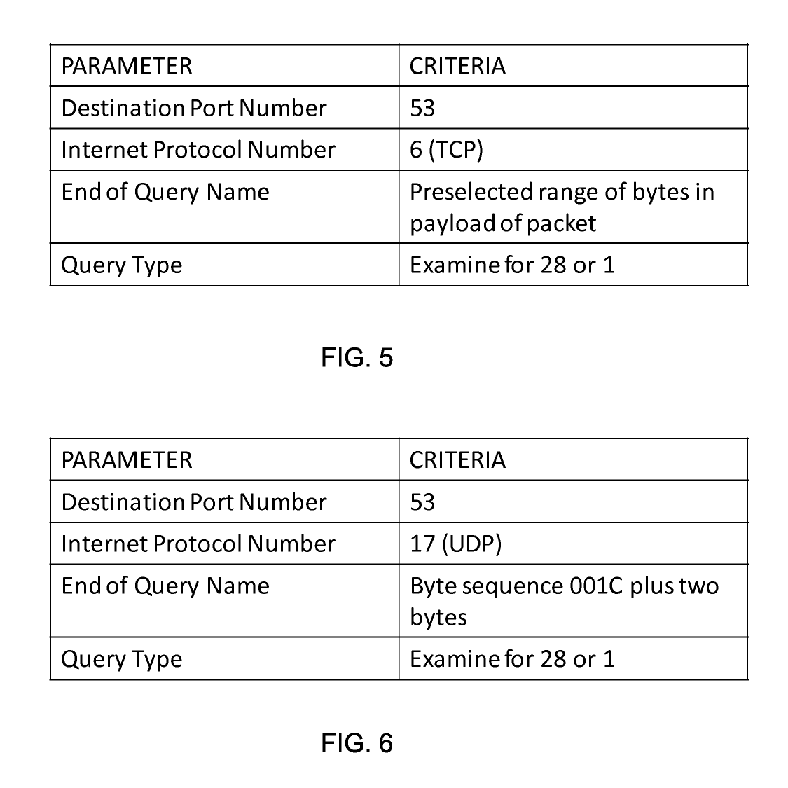

Once the data packet 354 is determined to be a DNS query packet and the particular IP format of the data packet 354 is determined (e.g., TCP or UDP), the Packet Inspection Unit 330 can examine the payload 358 of the data packet 354 to determine an end of a variable length query name of the data packet 354. For example, as shown in the table of FIG. 5, if the data packet 354 is a TCP IP format, the length of the query name is at a fixed location and can be determined at a preselected range of bytes within the payload of the packet. For example, in some embodiments, the length of the query name can be determined by examining bytes 96-99 of the payload of the packet. With the end of the query name identified, the location of the query type can then be determined because the query type is located after the end of the query name.

If the IP format of the data packet 354 is a UDP IP format, then the location of the end of the length of the query name is not fixed. To determine the end of the query name of a data packet having a UDP IP format, the payload of the data packet 354 is searched for a particular preselected byte sequence. In this example, the preselected byte sequence is 001C, as shown in the table of FIG. 6. The end of the query name will be located two bytes to the right of byte sequence 001C. As with the TCP IP format, the query type is located after the end of the query name.

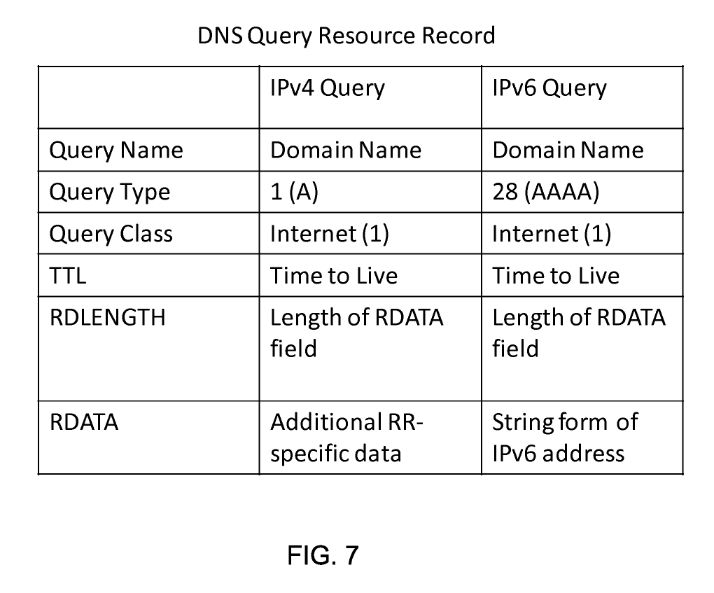

After determining the end of the query name as described above, the query type can then be determined by examining the DNS resource record for the query type included in the payload 358 of the data packet 354. If the data packet 354 includes an IPv4 query type, the DNS resource record for the query type will be 1, as shown in the table of FIG. 7. If the data packet 354 includes an IPv6 query type, the DNS resource record for the query type will be 28, also shown in FIG. 7.

With the query type known, the Packet Inspection Unit 330 can then make a determination as to whether to block the transmission of the data packet 354, allow it to be transmitted within Client Network 360 (e.g., to one or more computer devices 352), or send the data packet 354 for further processing. For example, if it has been determined that the data packet is to be blocked, the Packet Inspection Unit 330 can send a signal to block the data packet 354. In some embodiments, the signal can be sent within the Packet Inspection Unit 330 such that the Packet Inspection Unit 330 blocks transmission of the data packet 354. In some embodiments, the signal can be sent to the gateway device such that the gateway device can perform the indicated action (e.g., block transmission of the data packet). For example, it may be desirable to block transmission of an IPv4 DNS query packet that contains an IPv6 Query Type (i.e., AAAA query) to prevent any possible problems that could be associated with the query. For example, the inclusion of an IPv6 query type within an IPv4 data packet could indicate that the data packet contains malicious or harmful communications.

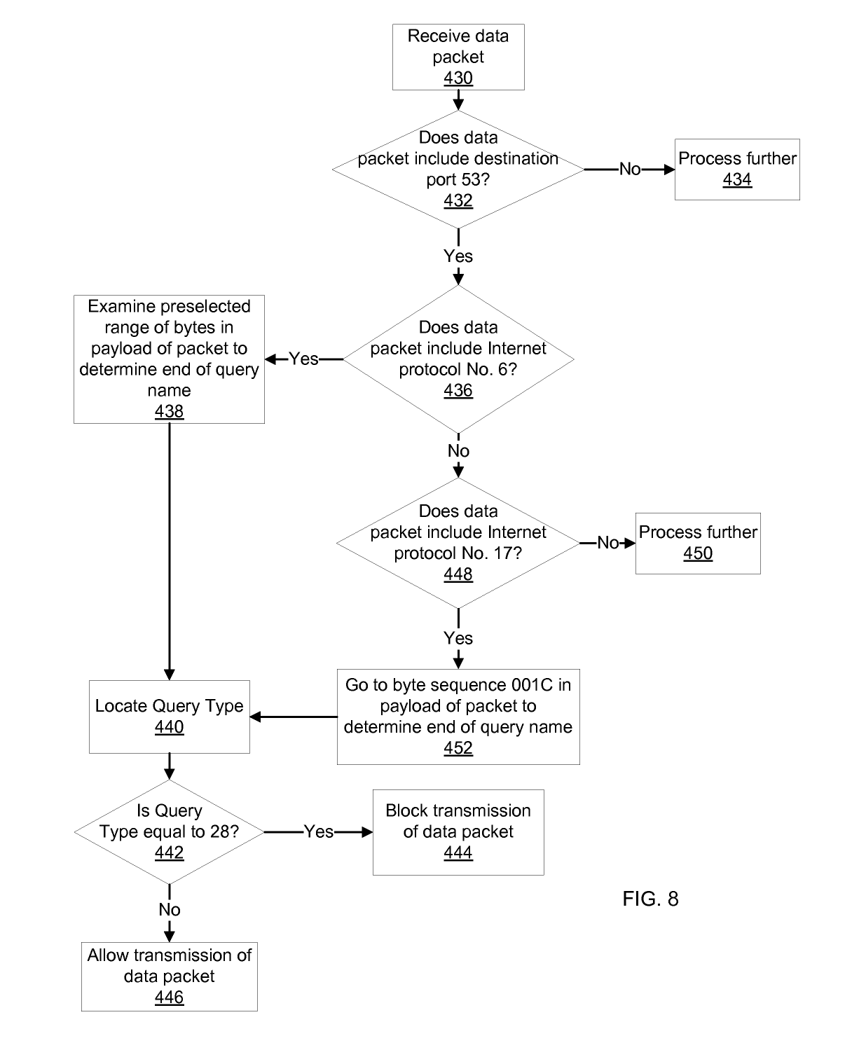

FIG. 8 is a flowchart illustrating a method of detecting an IPv6 query type within a DNS query packet, according to an embodiment. At 430, a data packet is received at a network server or system (e.g., system 100, 300), such as, for example, at a gateway device and/or a Packet Inspection Network (e.g., 120, 320) having one or more Packet Inspection Units, and that is in communication with a client network (e.g., Client Network 160 or Client Network 360), as described herein. The data packet can be, for example, an Internet Protocol version 4 (IPv4) or an Internet Protocol version 6 (IPv6) data packet, as described herein.

At 432, prior to allowing transmission of the data packet into the client network, a packet inspection unit can examine the header of the data packet to determine whether the data packet is a DNS query packet. For example, the packet inspection unit can determine if the header includes destination port 53. If the data packet does not include destination port 53, it is not a DNS query packet, and the data packet can then be blocked, allowed to proceed with transmission within the client network, or otherwise further processed, at 434. For example, additional filtering policies or inspections can optionally be performed on the data packet (i.e., non-DNS-query data packet) at 434 as desired.

If the data packet does contain destination port 53, the packet is a DNS query packet, and the packet inspection unit can, at 436, examine the header to determine if the data packet includes an Internet Protocol value of 6. If the data packet does include Internet Protocol No. 6, the data packet has a TCP transport layer format. At 438, the packet inspection unit can determine an end of a length of the query name by examining a preselected range of bytes in the payload of the packet. With the location of the end of the query name determined, the query type can be located at 440. The query type can be examined to determine if it includes resource record 28, indicating that the data packet is an IPv6 DNS query type (e.g., AAAA query). If the query type is equal to 28, the system can block transmission of the data packet at 442. If the query type is not equal to 28, the system can allow transmission of the data packet into the client network at 446. For example, as discussed above, in some embodiments, the packet inspection unit can send a signal within the packet inspection unit such that the packet inspection performs the indicated action (e.g., block transmission of the data packet or allow transmission of the data packet). In some embodiments, the packet inspection unit can send a signal to the gateway device such that the gateway device can perform the indicated action.

If, at 436, the packet does not include an Internet Protocol value of 6, at 448, the packet inspection unit can examine the header to determine if the data packet includes an Internet Protocol value of 17. If the data packet does not include an Internet Protocol value of 17, the packet can then be blocked or sent for further processing at 450. as desired. If the data packet does include an Internet Protocol value of 17, the data packet has a UDP format and at 452 the packet inspection unit can then examine the payload of the packet to determine the location of byte sequence 001C. The end of a length of the query name is located two bytes to the right of byte sequence 001C.

With the location of the end of the query name determined, at 440 the query type of the data packet can be located. At 442, the query type can be checked to determine if it includes resource record 28, indicating that the data packet is an IPv6 DNS query type. If the query type is equal to 28, the system can block transmission of the data packet at 444. If the query type is not equal to 28, the transmission of the data packet within the client network can be allowed at 446. For example, as discussed above, in some embodiments, the packet inspection unit can send a signal within the packet inspection unit such that the packet inspection performs the indicated action (e.g., block transmission of the data packet or allow transmission of the data packet). In some embodiments, the packet inspection unit can send a signal to the gateway device such that the gateway device can perform the indicated action.

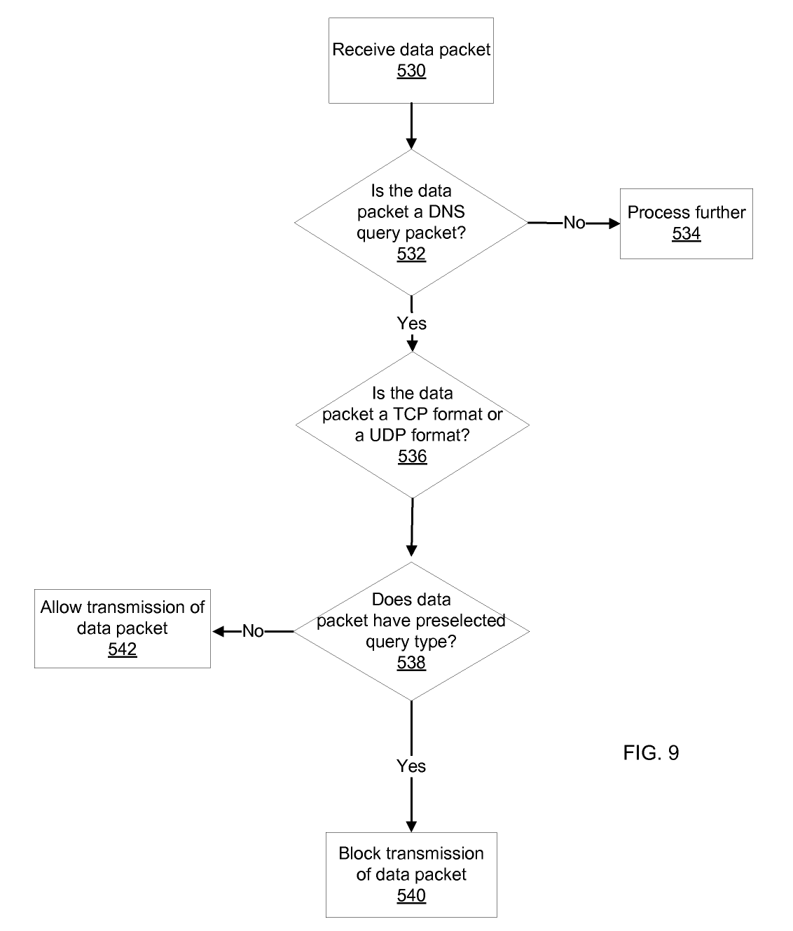

FIG. 9 is a flowchart illustrating a method of detecting a preselected query type within a DNS query packet, according to an embodiment. At 530 a data packet is received at a network server or system (e.g., system 100, 300), such as, for example, at a gateway device and/or a Packet Inspection Network (e.g., 120, 320) having one or more Packet Inspection Units, and that is in communication with a client network (e.g., Client Network 160 or Client Network 360), as described herein. The data packet can be, for example, an Internet Protocol version 4 (IPv4) or an Internet Protocol version 6 (IPv6) data packet, as described herein.

At 532, prior to allowing transmission of the data packet into the client network, the packet inspection unit can determine whether the data packet is a DNS query packet. For example, a header of the data packet can be examined. If the header includes a destination port value of 53, then the data packet is a DNS query packet. If it is not a DNS query packet, the packet can be blocked, allowed to proceed with transmission within the client network or otherwise be further processed at 534. For example, additional filtering policies or inspections can optionally be performed on the data packet (i.e., a non-DNS-query data packet) as desired.

At 536, the packet inspection unit can determine if the data packet has a User Datagram Protocol (UDP) format or a Transmission Control Protocol (TCP) format. For example, the header of the data packet can be examined to determine the Internet Protocol number of the data packet. At 538, the data packet can be examined to determine if the packet has a preselected query type based on a payload of the data packet and based on whether the packet has the UDP format or the TCP format. The preselected query type can be for example, an IPv6 DNS query type (e.g., AAAA query). If the data packet does contain the preselected query type, the packet inspection unit can block the transmission of the data packet at 540. If the data packet does not include the preselected query type, the system can allow transmission of the data packet at 542. For example, as discussed above, in some embodiments, the packet inspection unit can send a signal within the packet inspection unit such that the packet inspection performs the indicated action (e.g., block transmission of the data packet or allow transmission of the data packet). In some embodiments, the packet inspection unit can send a signal to the gateway device such that the gateway device can perform the indicated action.

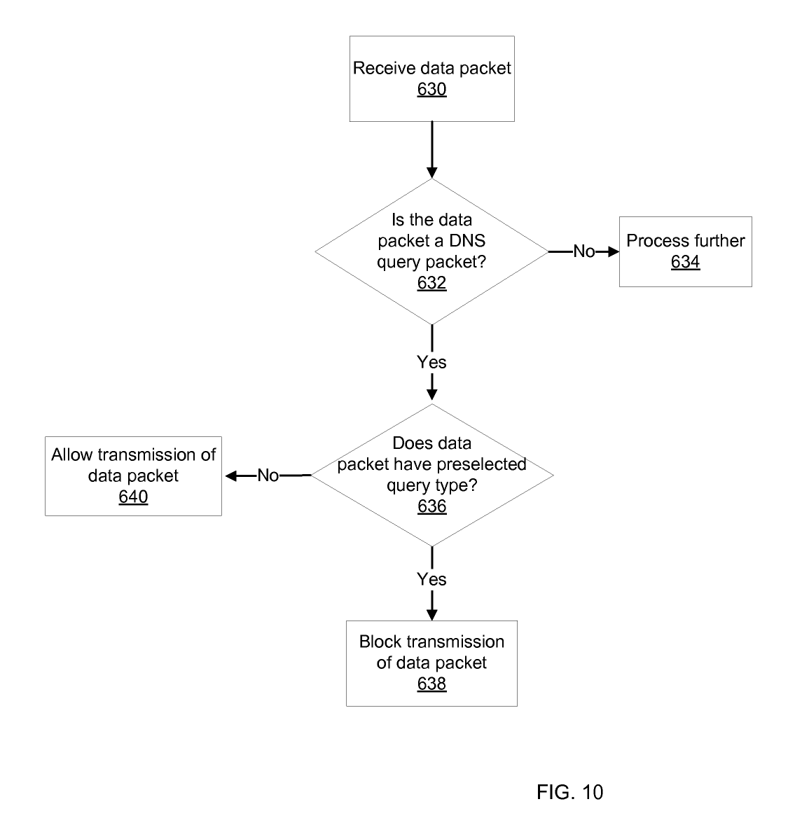

FIG. 10 is a flowchart illustrating a method of detecting a preselected query type according to an embodiment. At 630, a data packet is received at a network server or system (e.g., system 100, 300), such as, for example, at a gateway device and/or a Packet Inspection Network (e.g., 120, 320) having one or more Packet Inspection Units, and that is in communication with a client network (e.g., Client Network 160 or Client Network 360), as described herein. The data packet can be, for example, an Internet Protocol version 4 (IPv4) or an Internet Protocol version 6 (IPv6) data packet, as described herein.

At 632, prior to allowing transmission of the data packet into the network, the packet inspection unit can determine whether the data packet is a DNS query packet by examining a header of the data packet. For example, if the header includes a destination port value of 53, then the data packet is a DNS query packet. If it is not a DNS query packet, the packet can be blocked, allowed to proceed with transmission within the network, or otherwise further processed at 634. For example, additional filtering policies or inspections can optionally be performed on the data packet (i.e., a non-DNS-query data packet) as desired.

If the data packet is a DNS query packet, the packet inspection unit can examine the payload of the data packet to determine if the packet includes a preselected query type at 636. The preselected query type can be for example, an IPv6 DNS query type (e.g., AAAA query). If the data packet does contain the preselected query type, the system can block the transmission of the data packet at 638. If the data packet is not the preselected query type, the system can allow transmission of the data packet into the client network at 640. For example, as discussed above, in some embodiments, the packet inspection unit can send a signal within the packet inspection unit such that the packet inspection performs the indicated action (e.g., block transmission of the data packet or allow transmission of the data packet). In some embodiments, the packet inspection unit can send a signal to the gateway device such that the gateway device can perform the indicated action.

It is intended that the systems and methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

While various embodiments have been described above, it should be understood that they have been presented by way of example only, not limitation, and various changes in form and details may be made. Any portion of the systems, apparatuses and/or methods described herein may be combined in any combination, except mutually exclusive combinations. The embodiments described herein can include various combinations and/or sub-combinations of the functions, components and/or features of the different embodiments described. For example, in some embodiments, a packet filtering system can include two or more gateway devices similar to the Gateway Device 140 discussed in connection with FIG. 1 above. Furthermore, each feature disclosed herein may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A non-transitory processor-readable medium storing code representing instructions to cause a processor to:
determine whether an IPv4 packet is associated with a Domain Name System (DNS) query based on an IPv4 header of the IPv4 packet;
determine whether the IPv4 packet has a preselected query type based on a payload of the IPv4 packet when the IPv4 packet is the DNS query packet; and
send a signal to block transmission of the IPv4 packet when the IPv4 is the DNS query packet and has the preselected query type.

2. The non-transitory processor-readable medium of claim 1, wherein the preselected query type has a DNS record type value of 28.

3. The non-transitory processor-readable medium of claim 1, wherein the code to determine whether the IPv4 packet is associated with the DNS query includes code to examine a preselected range of bytes within the IPv4 header.

4. The non-transitory processor-readable medium of claim 1, wherein the code to determine whether the IPv4 packet is associated with the DNS query includes code to determine if the IPv4 packet includes a destination port having a preselected port number.

5. The non-transitory processor-readable medium of claim 1, further comprising code to:
determine whether the IPv4 packet has a User Datagram Protocol (UDP) format or a Transmission Control Protocol (TCP) format based on the IPv4 header of the IPv4 packet when the IPv4 packet is associated with the DNS query.

6. The non-transitory processor-readable medium of claim 1, further comprising code to:
determine whether the IPv4 packet has a User Datagram Protocol (UDP) format or a Transmission Control Protocol (TCP) format based on the IPv4 header of the IPv4 packet when the IPv4 packet is associated with the DNS query; and
determine an end of a query name of the IPv4 packet based on a preselected range of bytes within the payload of the IPv4 packet when the IPv4 packet has the TCP format and is associated with the DNS query,
the determining whether the IPv4 packet has the preselected query type being based on the end of the query name of the IPv4 packet when the IPv4 packet has the TCP format and is associated with the DNS query.

7. The non-transitory processor-readable medium of claim 1, further comprising code to:
determine whether the IPv4 packet has a User Datagram Protocol (UDP) format or a Transmission Control Protocol (TCP) format based on the IPv4 header of the IPv4 packet when the IPv4 packet is associated with the DNS query; and
determine an end of a query name of the IPv4 packet based on a preselected byte sequence within a payload of the IPv4 packet when the IPv4 packet has the UDP format and is associated with the DNS query,
the determining whether the IPv4 packet has a preselected query type being based on the end of the query name of the IPv4 packet when the IPv4 packet has the UDP format and is associated with the DNS query.

8. A non-transitory processor-readable medium storing code representing instructions to cause a processor to:
determine whether the IPv4 packet has a User Datagram Protocol (UDP) format based on a IPv4 header of the IPv4 packet when the IPv4 packet is associated with a Domain Name System (DNS) query;
determine an end of a query name of the IPv4 packet based on a preselected byte sequence within a payload of the IPv4 packet when the IPv4 packet has the UDP format and is associated with the DNS query;
determine whether the IPv4 packet has a preselected query type based on the end of the query name of the IPv4 packet when the IPv4 packet has the UDP format and is associated with the DNS query; and
send a signal to block transmission of the IPv4 packet when the IPv4 has the preselected query type and is associated with the DNS query.

9. The non-transitory processor-readable medium of claim 8, wherein the preselected query type has a DNS record type value of 28.

10. The non-transitory processor-readable medium of claim 8, wherein the IPv4 header is a UDP header when the IPv4 packet has the UDP format, the non-transitory processor-readable medium further comprising code to determine whether an IPv4 packet is associated with a DNS query based on a preselected range of bytes in the UDP header.

11. The non-transitory processor-readable medium of claim 8, wherein the IPv4 header is a UDP header when the IPv4 packet has the UDP format, the non-transitory processor-readable medium further comprising code to determine whether the IPv4 packet is associated with a DNS query based on the destination port number associated with the IPv4 packet.

12. The non-transitory processor-readable medium of claim 8, wherein the code to determine whether the IPv4 packet has a UDP format includes code to determine if the IPv4 header includes protocol 17.

13. The non-transitory processor-readable medium of claim 8, wherein the preselected byte sequence within a payload in the IPv4 packet includes byte sequence 001C.

14. The non-transitory processor-readable medium of claim 8, wherein the preselected byte sequence within a payload of the IPv4 packet includes byte sequence 001C, the determining an end of a query name of the IPv4 packet includes identifying the byte located two bytes to the right of byte sequence 001C.

15. A non-transitory processor-readable medium storing code representing instructions to cause a processor to:
determine whether an IPv4 packet is associated with a Domain Name System (DNS) query based on an IPv4 header of the IPv4 packet;
determine whether the IPv4 packet has a User Datagram Protocol (UDP) format or a Transmission Control Protocol (TCP) format based on a IPv4 header of the IPv4 packet when the IPv4 packet is associated with the DNS query;
determine whether the IPv4 packet has a preselected query type based on a payload of the IPv4 packet and based on whether the IPv4 packet has the UDP format or the TCP format; and
send a signal to block transmission of the IPv4 packet when the IPv4 has the preselected query type and is associated with the DNS query.

16. The non-transitory processor-readable medium of claim 15, wherein the preselected query type has a DNS record type value of 28.

17. The non-transitory processor-readable medium of claim 15, wherein the code to determine whether an IPv4 packet is associated with a DNS query includes code to examine a preselected range of bytes of the IPv4 header.

18. The non-transitory processor-readable medium of claim 15, wherein the code to determine whether an IPv4 packet is associated with a DNS query includes code to determine if the IPv4 packet includes destination port number 53.

19. The non-transitory processor-readable medium of claim 15, further comprising code to:
determine an end of a query name of the IPv4 packet based on a preselected range of bytes within the payload of the IPv4 packet when the IPv4 packet has the TCP format and is associated with the DNS query,
the determining whether the IPv4 packet has the preselected query type being based on the end of the query name of the IPv4 packet when the IPv4 packet has the TCP format and is associated with the DNS query.

20. The non-transitory processor-readable medium of claim 15, further comprising code to:
determine an end of a query name of the IPv4 packet based on a preselected byte sequence within a payload of the IPv4 packet when the IPv4 packet has the UDP format and is associated with the DNS query,
the determining whether the IPv4 packet has the preselected query type being based on the end of the query name of the IPv4 packet when the IPv4 packet has the UDP format and is associated with the DNS query.
